(19) United States
(12) Patent Application Publication
(10) Pub. No.: US 2024/0067533 A1
(43) Pub. Date: Feb. 29, 2024

(54) CATHODE ACTIVE MATERIAL AND METHOD FOR MANUFACTURING THE SAME

(71) Applicant: KOREA NATIONAL UNIVERSITY OF TRANSPORTATION INDUSTRY-ACADEMIC COOPERATION FOUNDATION, Chungju-si (KR)

(72) Inventors: Jong Tae SON, Daejeon (KR); Hae In KIM, Chungju-si (KR)

(21) Appl. No.: 18/239,942

(22) Filed: Aug. 30, 2023

(30) Foreign Application Priority Data
Aug. 31, 2022 (KR) 10-2022-0109594

(51) Int. Cl. C01G 53/00; D01D 5/00; D01D 10/02; D01F 8/18; D01F 9/08

(52) U.S. Cl. CPC C01G 53/42; D01D 5/0007; D01D 10/02; D01F 8/18; D01F 9/08; C01P 2004/16; C01P 2004/62; C01P 2006/40; D10B 2101/02; D10B 2101/12

(57) ABSTRACT

The present disclosure relates to a cathode active material and a method for manufacturing the same, and in particular, to a cathode active material capable of accelerating charge transfer and lithium ion diffusion by shortening a distance of lithium diffusion through electrospinning a mixture solution for manufacturing the cathode active material, and a method for manufacturing the same.

### CROSS-REFERENCE TO RELATED APPLICATIONS

The present disclosure claims the benefit of Korean Patent Application No. 10-2022-0109594, filed with the Korean Intellectual Property Office on Aug. 31, 2022, the contents of which are incorporated herein by reference in their entirety.

### TECHNICAL FIELD

The present disclosure relates to a cathode active material and a method for manufacturing the same, and in particular, to a cathode active material capable of accelerating charge transfer and lithium ion diffusion by shortening a distance of lithium diffusion through electrospinning a mixture solution for manufacturing the cathode active material, and a method for manufacturing the same.

### BACKGROUND ART

Batteries are generally divided into primary batteries for single use and secondary batteries that is usable after recharge. As recent trends of electronic devices toward miniaturization have been gradually diversified into portable phones, laptop computers (PC), portable personal digital assistants (PDA) and the like, interests in secondary battery technologies are increasing. Furthermore, as electric vehicles (EV) or hybrid electric vehicles (HEV) are commercialized, studies on secondary batteries with high capacity and output and excellent stability are actively ongoing.

A secondary battery is formed with a cathode, an anode, an electrolyte liquid and the like, and among the costs of various materials, the cost proportion of the cathode is highest. Generally, a cathode material of a lithium ion secondary battery needs to have its structure to be not destroyed by intercalation and deintercalation of reversible lithium ions while having high energy density during charge and discharge, and needs to have high electrical conductivity and have high chemical stability for organic solvents used as an electrolyte. Furthermore, materials with low manufacturing costs and minimized environmental pollution problems are preferred.

As a method for preparing a composite metal oxide to be used as a cathode active material of a lithium ion secondary battery, a solid phase method and a co-precipitation method are generally used. The solid phase method has disadvantages in that it is difficult to obtain a uniform composition due to a large influx of impurities during mixing, a high temperature is required in the manufacturing process, and a time for manufacturing is long. The co-precipitation method is a method of obtaining an active material through mixing a precursor obtained by, using sodium hydroxide as a co-precipitator and a chelating agent as a complexing agent in an aqueous solution including Ni, Co, Mn, simultaneously precipitating these with a lithium (Li) salt, and then calcining the result. The co-precipitation method has an advantage over the solid phase method in that it is possible to obtain a material with a uniform composition, but has problems in that the particle size of the active material is affected by the particle size of the precursor, and the optimization process requires much effort and time since there are many process variables in the synthesis process and the process is complicated.

### DISCLOSURE

### Technical Problem

The present disclosure is directed to providing a cathode active material having excellent electrochemical properties, and a method for manufacturing the same.

However, objects to be addressed by the present disclosure are not limited to the object mentioned above, and other objects not mentioned will be clearly appreciated by those skilled in the art from the following description.

### Technical Solution

One embodiment of the present disclosure provides a method for manufacturing a cathode active material, the method including: preparing a mixture solution including a raw material quantified in a chemical stoichiometric ratio according to a composition formula of Li[NiₓM₁₋ₓ]O₂ (0.85≤x≤0.93, M is Mn, Co, V, Cr, Cu, Ti or Zn), a chelating agent and a solvent; preparing a nanofiber by electrospinning the mixture solution; and heat treating the nanofiber to prepare a cathode active material provided with a carbon coating layer on a surface of the nanofiber.

One embodiment of the present disclosure provides a cathode active material manufactured using the above-described method, the cathode active material including: a nanofiber having a composition formula of Li[NiₓM₁₋ₓ]O₂ (0.85≤x≤0.93, M is Mn, Co, V, Cr, Cu, Ti or Zn); and a carbon coating layer provided on a surface of the nanofiber.

### Advantageous Effects

A manufacturing method according to one embodiment of the present disclosure is capable of manufacturing a cathode active material with excellent electrochemical properties more readily.

A cathode active material according to one embodiment of the present disclosure can have excellent electrochemical properties.

Effects of the present disclosure are not limited to the above-described effects, and effects not mentioned will be clearly appreciated by those skilled in the art from the present specification and accompanying drawings.

### BRIEF DESCRIPTION OF DRAWINGS

FIG. 1 shows SEM images of Example 1 and Comparative Example 1.

FIG. 2 is a graph obtained by analyzing Example 1 and Comparative Example 1 using an X-ray diffraction analyzer.

FIG. 3 shows initial charge-discharge capacity curves for cathodes of Example 1 and Comparative Example 1.

FIG. 4 shows cycle number-dependent differential capacity plots with respect to a voltage for a cathode of Example 1.

FIG. 5 shows cycle number-dependent electrochemical properties for cathodes of Example 1 and Comparative Example 1 of the present disclosure.

FIG. 6 shows capacity efficiency properties for cathodes of Example 1 and Comparative Example 1.

FIG. 7 (a) shows Nyquist plots (Z′ vs −Z″) after 1 cycle for cathodes of Example 1 and Comparative Example 1.

FIG. 7(b) shows Nyquist plots (Z′ vs −Z″) after 20 cycles for cathodes of Example 1 and Comparative Example 1.

### MODE FOR INVENTION

Throughout the present specification, a description of a certain part “including” certain constituents means capable of further including other constituents, and does not exclude other constituents unless particularly stated on the contrary.

Throughout the present specification, a description of a certain member being placed “on” another member includes not only a case of the certain member being in contact with the another member but a case of still another member being present between the two members.

Hereinafter, the present disclosure will be described in more detail.

One embodiment of the present disclosure provides a method for manufacturing a cathode active material, the method including: preparing a mixture solution including a raw material quantified in a chemical stoichiometric ratio according to a composition formula of Li[NiₓM₁₋ₓ]O₂ (0.85≤x≤0.93, M is Mn, Co, V, Cr, Cu, Ti or Zn), a chelating agent and a solvent; preparing a nanofiber by electrospinning the mixture solution; and heat treating the nanofiber to prepare a cathode active material provided with a carbon coating layer on a surface of the nanofiber.

Using the manufacturing method according to one embodiment of the present disclosure, a cathode active material with excellent electrochemical properties may be manufactured more readily. Specifically, the method for manufacturing a cathode active material is capable of accelerating charge transfer and lithium ion diffusion by shortening a distance of lithium diffusion of a nanofiber, a basis of a cathode active material, using an electrospinning method, and is capable of manufacturing a cathode active material with excellent electrochemical properties more readily.

In addition, a cathode active material manufactured using the method according to one embodiment of the present disclosure has, as to be described later, excellent electrochemical properties such as high capacity and capacity retention rate, excellent lifetime properties (cycling properties) and high lithium mobility, and has excellent structural stability, and therefore, may be readily used in various fields such as electric vehicles and multipurpose electric devices.

According to one embodiment of the present disclosure, a raw material quantified in a chemical stoichiometric ratio according to a composition formula of Li[NiₓM₁₋ₓ]O₂ (0.85≤x≤0.93, M is Mn, Co, V, Cr, Cu, Ti or Zn) may be prepared. By using a raw material quantified in a chemical stoichiometric ratio according to the composition formula having a high nickel ratio, electrochemical properties of a prepared cathode active material may be further improved.

According to one embodiment of the present disclosure, x is 0.85 or greater and 0.93 or less, 0.86 or greater and 0.93 or less, 0.87 or greater and 0.93 or less, 0.88 or greater and 0.93 or less, and 0.89 or greater and 0.93 or less in the composition formula. Specifically, x is preferably 0.93 in the composition formula. When the value of x satisfies the above-described range in the composition formula, a cathode active material with excellent electrochemical properties may be manufactured.

According to one embodiment of the present disclosure, M is Co in the composition formula, and the raw material may include lithium nitrate hexahydrate (LiNO₃·6H₂O), nickel nitrate hexahydrate (Ni(NO₃)₂·6H₂O) and cobalt nitrate hexahydrate (Co(NO₃)₂·6H₂O). By using the above-described types of raw material, a nanofiber of Li[NiₓM₁₋ₓ]O₂ (0.85≤x≤0.93, M is Mn, Co, V, Cr, Cu, Ti or Zn) may be readily prepared.

Meanwhile, when M is Mn in the composition formula, the raw material may include manganese nitrate hydrate instead of cobalt nitrate hexahydrate. Likewise, vanadium nitrate hydrate may be used when M is V, chromium nitrate hydrate may be used when M is Cr, copper nitrate hydrate may be used when M is Cu, titanium nitrate hydrate may be used when M is Ti, and zinc nitrate hydrate may be used when M is Zn.

According to one embodiment of the present disclosure, the chelating agent may include at least one of polyvinyl pyrrolidine (PVP), polyvinyl acetate (PVAc), polyvinyl alcohol (PVA), polyethylene (PE), polypropylene (PP) and poly(3,4-ethylenedioxythiophene) (PEDOT). By using the above-described types of chelating agent, a carbon coating layer may be readily formed on a surface of the nanofiber.

According to one embodiment of the present disclosure, the solvent may be a complex solvent. Specifically, the solvent may be a complex solvent including distilled water, an acid and an alcohol. More specifically, the solvent may be a complex solvent including distilled water, nitric acid and methanol. By using the complex solvent, the raw material and the chelating agent may be more homogeneously dispersed in the mixture solution.

According to one embodiment of the present disclosure, the content of the chelating agent may be 10 parts by weight or greater and 20 parts by weight or less in the mixture solution with respect to 100 parts by weight of the raw material. Specifically, the content of the chelating agent included in the mixture solution may be 12 parts by weight or greater and 19 parts by weight or less, 15 parts by weight or greater and 18.5 parts by weight or less, 10 parts by weight or greater and 15 parts by weight or less, 15 parts by weight or greater and 20 parts by weight or less, 17.5 parts by weight or greater and 20 parts by weight or less, or 18 parts by weight or greater and 20 parts by weight or less with respect to 100 parts by weight of the raw material. When the content of the chelating agent is in the above-described range, the nanofiber may be readily prepared using an electrospinning method, and a carbon coating layer may be effectively formed on a surface of the prepared nanofiber.

According to one embodiment of the present disclosure, the content of the solvent included in the mixture solution may be 100 parts by weight or greater and 300 parts by weight or less with respect to 100 parts by weight of the raw material. Specifically, the content of the solvent included in the mixture solution may be 150 parts by weight or greater and 250 parts by weight or less, 180 parts by weight or greater and 230 parts by weight or less, 150 parts by weight or greater and 210 parts by weight or less, or 200 parts by weight or greater and 250 parts by weight or less with respect to 100 parts by weight of the raw material. When the content of the solvent is in the above-described range, the mixture solution may have viscosity suitable for electrospinning.

According to one embodiment of the present disclosure, the mixture solution may have viscosity of 0.1 Pa·s or greater and 1.5 Pa·s or less at room temperature. By adjusting the viscosity of the mixture solution in the above-described range, a thickness of the nanofiber may be properly adjusted during electrospinning.

According to one embodiment of the present disclosure, the nanofiber may be prepared from the mixture solution through an electrospinning method. By using electrospinning, a nanofiber with a shortened distance of lithium diffusion and an increased surface area may be readily prepared. In addition, by adjusting a voltage condition for performing electrospinning, a supply speed of the mixture solution, viscosity of the mixture solution and the like, a nanofiber having a desired shape may be readily prepared.

According to one embodiment of the present disclosure, the electrospinning may be performed in a voltage range of 10 kV or greater and 30 kV or less and a TCD (tip-to-collector distance) range of 5 cm or greater and 20 cm or less. Specifically, a voltage condition of the electrospinning may be 10 kV or greater and 25 kV or less, 10 kV or greater and 20 kV or less, 15 kV or greater and 20 kV or less, or 15 kV or greater and 17 kV or less. In addition, a TCD when performing the electrospinning may be 10 cm or greater and 20 cm or less, 10 cm or greater and 13 cm or less, or 11 cm or greater and 13 cm or less. By performing electrospinning under the above-described condition, the nanofiber may be effectively formed, and the formed nanofiber may be prevented from being destroyed during heat treatment.

According to one embodiment of the present disclosure, the nanofiber is heat treated to provide a carbon coating layer on a surface of the nanofiber. Specifically, when the nanofiber is heat treated, polyvinyl pyrrolidone (PVP) is carbonized and a surface of the nanofiber is provided with a PVP carbon coating layer, and as a result, electrochemical properties of a cathode may be further improved.

According to one embodiment of the present disclosure, the heat treating of the nanofiber may include a first heat treatment performed at a temperature of 400° C. or higher and 550° C. or lower and a second heat treatment performed at a temperature of 600° C. or higher and 900° C. or lower. Specifically, the temperature at which the first heat treatment is performed may be 400° C. or higher and 500° C. or lower, 400° C. or higher and 450° C. or lower, or 450° C. or higher and 500° C. or lower. In addition, the temperature at which the second heat treatment is performed may be 650° C. or higher and 850° C. or lower, 700° C. or higher and 800° C. or lower, 600° C. or higher and 750° C. or lower, or 700° C. or higher and 900° C. or lower. By adjusting the temperatures of the first heat treatment performed at a relatively low temperature and the second heat treatment performed at a relatively high temperature in the above-described range, the nanofiber may effectively form a phase with the material of the above-mentioned composition formula while maintaining its shape.

According to one embodiment of the present disclosure, a time for which the first heat treatment is performed may be 3 hours or longer and 6 hours or shorter, and a time for which the second heat treatment is performed may be 10 hours or longer and 15 hours or shorter.

According to one embodiment of the present disclosure, the step of the first heat treatment and the step of the second heat treatment may be heating at a heating rate of 1° C./minute or greater and 5° C./minute or less. By adjusting the heating rate of the step of the first heat treatment and the step of the second heat treatment in the above-described range, the nanofiber may be prevented from being denatured.

According to one embodiment of the present disclosure, the step of the first heat treatment and the step of the second heat treatment may be performed under the oxygen atmosphere. By performing the step of the first heat treatment and the step of the second heat treatment under the oxygen atmosphere as described above, other atoms may be prevented from being included in the cathode active material.

One embodiment of the present disclosure provides a cathode active material manufactured using the above-described method, the cathode active material including: a nanofiber having a composition formula of Li[NiₓM₁₋ₓ]O₂ (0.85≤x≤0.93, M is Mn, Co, V, Cr, Cu, Ti or Zn); and a carbon coating layer provided on a surface of the nanofiber.

The cathode active material according to one embodiment of the present disclosure may have excellent electrochemical properties. Specifically, the cathode active material has excellent electrochemical properties such as high capacity and capacity retention rate, excellent lifetime properties (cycling properties) and high lithium mobility, and has excellent structural stability, and therefore, may be readily used in various fields such as electric vehicles and multipurpose electric devices.

According to one embodiment of the present disclosure, x may be 0.85 or greater and 0.93 or less, 0.86 or greater and 0.93 or less, 0.87 or greater and 0.93 or less, 0.88 or greater and 0.93 or less, 0.89 or greater and 0.93 or less, or 0.93 in the composition formula. When the value of x satisfies the above-described range in the composition formula, electrochemical properties of the cathode active material may be effectively improved.

According to one embodiment of the present disclosure, the nanofiber may have an average diameter of 300 nm or greater and 900 nm or less. When the average diameter of the nanofiber is in the above-described range, side reactions between the cathode active material and an electrolyte may be suppressed, and structural stability and electrochemical properties of the cathode active material may be effectively improved. According to one embodiment of the present disclosure, the nanofiber may include a crystalline active material. As described above, the cathode active material including the nanofiber containing a crystalline active material may have excellent electrochemical properties.

According to one embodiment of the present disclosure, the cathode active material includes a carbon coating layer provided on a surface of the nanofiber. The carbon coating layer may be provided by heat treating the electrospun nanofiber. By including the carbon coating layer provided on the surface of the nanofiber as described above, the cathode active material may have improved electrochemical properties.

One embodiment of the present disclosure provides a method for manufacturing a lithium ion secondary battery, the method including: preparing a cathode active material using the above-described method; preparing a slurry including the cathode active material; preparing a cathode plate by coating the slurry on a current collector; and manufacturing a lithium ion secondary battery including the cathode plate, an anode plate and an electrolyte liquid.

A lithium ion secondary battery is largely formed with a cathode plate, an anode plate and an electrolyte liquid, and in the process of preparing a cathode plate among these, a process of preparing a cathode active material using the above-described method and then coating the result on a current collector to prepare the cathode plate may be included. Other constitutions of the lithium ion secondary battery and preparation steps thereof are not particularly limited, and all known constitutions and preparation steps may be used. Therefore, a detailed description will not be included.

According to one embodiment of the present disclosure, the slurry may further include a binder and carbon black. By the slurry further including a binder and carbon black as described above, electrochemical properties of the cathode may be improved.

According to one embodiment of the present disclosure, the binder may be N-methyl-2-pyrrolidone. By selecting N-methyl-2-pyrrolidone as a material of the binder as described above, inhibiting charge transfer of the cathode may be prevented.

According to one embodiment of the present disclosure, the binder may have a concentration of 5% by weight or greater and 15% by weight or less. By adjusting the concentration of the binder in the above-described range, the slurry may be readily coated by adjusting viscosity thereof.

According to one embodiment of the present disclosure, the content of the cathode active material may be 700 parts by weight or greater and 900 parts by weight or less in the slurry with respect to 100 parts by weight of the binder. By adjusting the content of the cathode active material as described above in the slurry, electrochemical properties of the cathode may be improved.

According to one embodiment of the present disclosure, the content of the carbon black may be 50 parts by weight or greater and 150 parts by weight or less in the slurry with respect to 100 parts by weight of the binder. By adjusting the content of the carbon black in the above-described range in the slurry, electrochemical properties of the cathode may be improved.

According to one embodiment of the present disclosure, a material of the current collector may be aluminum. By selecting aluminum as a material of the current collector as described above, electrochemical properties of the cathode may be improved.

According to one embodiment of the present disclosure, a step of drying the slurry may be further included after the preparing of a cathode plate by coating the slurry on a current collector. By further including the drying of the slurry as described above, the cathode may be readily prepared.

According to one embodiment of the present disclosure, the drying of the slurry may be vacuum drying the slurry for 2 hours or longer and 4 hours or shorter at 100° C. or higher and 150° C. or lower. By adjusting the temperature and the time of the drying of the slurry in the above-described range, the cathode may be readily prepared.

According to one embodiment of the present disclosure, the manufacturing of a lithium ion secondary battery including the cathode plate, an anode plate and an electrolyte liquid may be manufacturing under the argon atmosphere. By performing the manufacturing of a lithium ion secondary battery including the cathode plate, an anode plate and an electrolyte liquid under the argon atmosphere as described above, side reactions caused by atoms included in the air may be prevented from occurring.

Hereinafter, the present disclosure will be described in detail with reference to examples in order to specifically describe the present disclosure. However, the examples according to the present disclosure may be modified to various different forms, and the scope of the present disclosure is not construed as being limited to the examples described below. The examples of the present specification are provided in order to more fully describe the present disclosure to those having average knowledge in the art.

### Example 1 (Manufacture of Cathode Active Material Using Electrospinning)

Preparation of Nanofiber

In order to prepare a nanofiber having a composition formula of Li[Ni_{0.93}Co_{0.07}]O₂, a raw material formed with lithium nitrate hexahydrate (LiNO₃·6H₂O) (3.4475 g), nickel nitrate hexahydrate (Ni(NO₃)₂·6H₂O) (13.521 g) and cobalt nitrate hexahydrate (Co(NO₃)₂·6H₂O) (1.0185 g) was prepared. As a chelating agent, polyvinyl pyrrolidone (PVP) (3.3 g) was prepared. As a solvent, a complex solvent formed with distilled water (18 g), methanol (15 g) and nitric acid (HNO₃) (4.28 g) was prepared. After that, the prepared raw material, chelating agent and complex solvent were stirred at a rotation speed of 300 rpm to prepare a mixture solution.

The prepared mixture solution was introduced to a syringe of an electrospinning device (NanoNC Co., Ltd., linear actuator), and electrospinning was performed to prepare a nanofiber. Herein, a voltage for performing the electrospinning was adjusted to about 16 kV, and TCD was adjusted to about 13 cm. The prepared nanofiber was subject to a first heat treatment for 5 hours at 450° C. and a second heat treatment for 12 hours at 750° C. at a heating rate of 3° C./min under the oxygen atmosphere to manufacture a nanofiber that is a cathode active material.

### Comparative Example 1 (Manufacture of Cathode Active Material Using Co-precipitation)

In order to prepare spherical particles having a composition formula of Li[Ni_{0.93}Co_{0.07}]O₂, a mixture of nickel sulfate hexahydrate (NiSO₄·6H₂O) and cobalt sulfate heptahydrate (CoSO₄·7H₂O) was co-precipitated to prepare a Ni_{0.93}Co_{0.07}(OH)₂ precursor. LiNiO₂ was added to the Ni_{0.93}Co_{0.07}(OH)₂ to prepare a mixture, and then the mixture was heated.

Specifically, a metal solution including nickel sulfate hexahydrate (NiSO₄·6H₂O) (1,564.48 g) having a concentration of 1.49 mol/L and cobalt sulfate heptahydrate (CoSO₄·7H₂O) (125.93 g) having a concentration of 0.11 mol/L was injected into a tank reactor (4 L) continuously stirred under the N₂ atmosphere by pumping, and at the same time, a 25 wt % NaOH solution (900 ml) and a 25 wt % NH₄OH solution (240 ml) that is a chelating agent were separately injected into the reactor by pumping. The pH of the entire reaction inside the reactor was maintained between 11.5 and 12.0, and the temperature was adjusted to 53° C. to prepare the Ni_{0.93}Co_{0.07}(OH)₂ precursor. After that, the obtained Ni_{0.93}Co_{0.07}(OH)₂ precursor was ball-milled with dry powder of LiOH·H₂O, and calcined for 12 hours at 750° C. to manufacture an active material that is a spherical particle. The calcination was performed at a heating rate of 3° C./min under the 02 atmosphere.

### Experimental Example

Using experimental devices as follows, properties of the manufactured cathode active materials were observed and evaluated.
1. SEM: JSM-7610F; JEOL Ltd.
2. EIS (electrochemical impedance spectroscopy): performed under temperature condition of 25° C., frequency condition in the range of 0.01 Hz to 0.1 MHz, and condition of alternating current with amplitude of 10 mV
3. Nyquist plots (Z′ vs −Z″): used Z plot and Z view software (IviumStat)

Shape Analysis

FIGS. 1 (a) and (b) are SEM images of the nanofiber that is the cathode active material manufactured in Example 1. FIGS. 1 (c) and (d) are SEM images of the cathode active material manufactured in Comparative Example 1 of the present disclosure.

Referring to FIG. 1, it was identified that the nanofiber that is the cathode active material manufactured in Example 1 had an average diameter of about 500 nm to 700 nm, and the spherical particle manufactured in Comparative Example 1 had a size of about 250 nm to 300 nm. It was identified that the nanofiber of Example 1 shortened a distance of lithium diffusion, thereby accelerating charge transfer and lithium ion diffusion.

Electrochemical Property Analysis

Using a CR2032 nose doll cell, electrochemical properties of the cathode active materials manufactured in Example 1 and Comparative Example 1 were analyzed.

Specifically, the cathode active material manufactured in Example 1 was prepared. A binder formed with N-methyl-2-pyrrolidone (10 wt %) and water (90 wt %) was prepared. Then, carbon black (Super P carbon black) was prepared. After that, the cathode active material, the binder and the carbon black were mixed to prepare a slurry. Herein, the content of the cathode active material was 80 wt %, the content of the binder was 10 wt %, and the content of the carbon black was 10 wt %.

After that, the prepared slurry was uniformly coated on aluminum foil, and vacuum dried for 3 hours at 120° C. to prepare an electrode plate. After that, the electrode plate was assembled in a glove box filled with argon gas to prepare a cathode.

A cathode was prepared in the same manner as above using the cathode active material manufactured in Comparative Example 1.

After that, electrochemical property tests for the cathodes of Example 1 and Comparative Example 1 were performed at 3.0 V to 4.3 V.

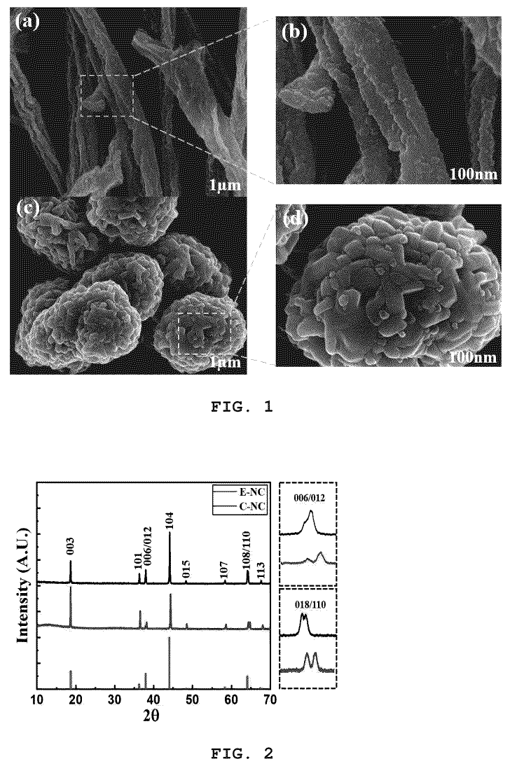

FIG. 2 is a graph obtained by analyzing Example 1 and Comparative Example 1 using an X-ray diffraction analyzer (XRD). Referring to FIG. 2, it can be identified through the XRD results that crystallinity is improved. Specifically, it can be identified that values of the I(003)/I(104) ratio representing a cation mixing phenomenon and the c/a ratio representing a cation arranged structure are high. In addition, improvement in crystallinity was identified through clear expression of peak splits in (006)/(102) and (018)/(110).

The following Table 1 summarizes lattice parameters according to the XRD results of Example 1 and Comparative Example 1.

TABLE 1

| | a | c | | V | I(003)/ | R- |
|---|---|---|---|---|---|---|
| | (Å) | (Å) | c/a | (Å³) | I(104) | factor |
| Example 1 | 2.8762 | 14.1931 | 4.93 | 101.67 | 1.19 | 0.68 |
| | (±0.0001) | (±0.0002) | (±0.01) | (±0.01) | | |
| Comparative | 2.8950 | 14.2233 | 4.91 | 103.23 | 0.46 | 2.65 |
| Example 1 | (±0.0001) | (±0.0002) | (±0.01) | (±0.01) | | |

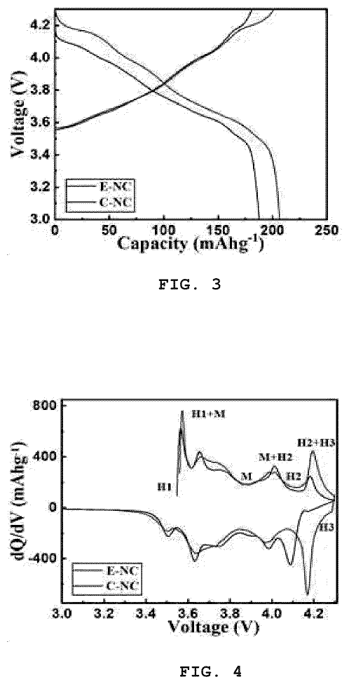

Referring to Table 1, the cation mixing phenomenon occurs when an excessive amount of nickel is included in the cathode active material, causing a problem of limiting lithium ion migration. In Table 1, the cation mixing phenomenon is reduced as the I(003)/I(104) ratio increases, and a higher I(003)/I(104) ratio is identified in Example 1, and therefore, it was identified that Example 1 was able to have low cation mixing and excellent electrochemical properties. FIG. 3 shows initial charge-discharge capacity curves for the cathodes of Example 1 and Comparative Example 1 of the present disclosure. Specifically, FIG. 3 shows initial charge-discharge capacity curves for the cathodes including the cathode active materials manufactured in Example 1 and Comparative Example 1 in a voltage range of 3.0 V to 4.3 V at 0.1 C.

Referring to FIG. 3, Example 1 shows initial discharge capacity of 206 mAhg⁻¹ at 0.1 C, whereas Comparative Example 1 shows initial discharge capacity of 189.2 mAhg⁻¹ at 0.1 C, and therefore, it was identified that Example 1 had excellent discharge capacity compared to Comparative Example 1.

FIG. 4 shows differential capacity plots with respect to a voltage for the cathodes of Example 1 and Comparative Example 1. Specifically, FIG. 4 shows differential capacity plots with respect to a voltage for the cathodes of Example 1 and Comparative Example 1 in a voltage range of 3.0 V to 4.3 V at 0.1 C.

Referring to FIG. 4, Example 1 had a reduced overvoltage compared to Comparative Example 1 in the first cycle, and it was identified that this was a result of the nanofiber structure accelerating lithium (Li) ion diffusion, and the carbon coating suppressing side reactions with the electrolyte.

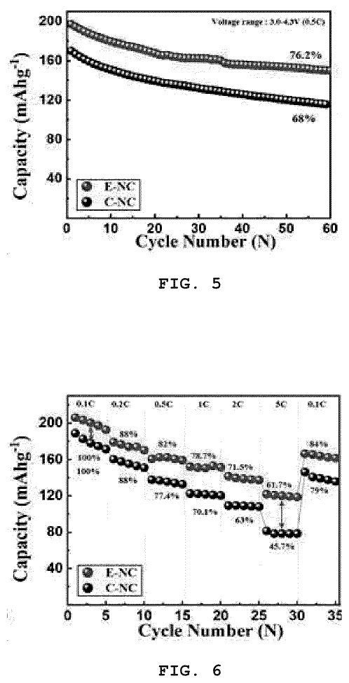

FIG. 5 shows cycle number-dependent electrochemical properties for the cathodes of Example 1 and Comparative Example 1 of the present disclosure. Specifically, FIG. 5 shows cycle number-dependent discharge capacity for the cathodes of Example 1 and Comparative Example 1 at 0.5 C.

Referring to FIG. 5, it was identified that Example 1 had discharge capacity of 152.12 mAhg⁻¹ after performing 60 cycles at 0.5 C, which corresponds to a capacity retention rate of 76.2%, whereas Comparative Example 1 had discharge capacity of 115.17 mAhg⁻¹, which corresponds to a capacity retention rate of 68%. Through this, it can be seen that the carbon coating layer suppresses side reactions from occurring in the nanofiber material, and higher discharge capacity may be obtained thereby.

FIG. 6 shows capacity efficiency properties for the cathodes of Example 1 and Comparative Example 1. Referring to FIG. 6, it was identified that, although Example 1 and Comparative Example 1 had similar capacity efficiency in the cathodes at the beginning, Example 1 had higher capacity efficiency compared to Comparative Example 1 as the discharge rate increased. Particularly, it was identified that Example 1 had about 16% higher capacity efficiency compared to Comparative Example 1 at the discharge rate of 5 C. Through this, it can be seen that, in Example 1, improved capacity may be maintained even at a high discharge rate by forming the carbon coating layer.

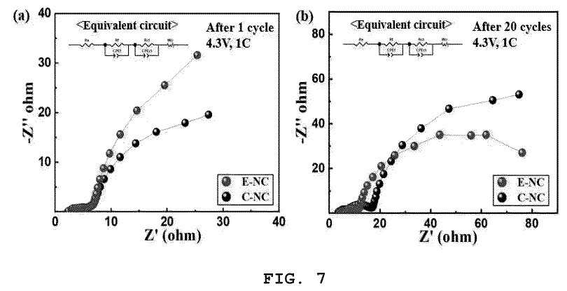

FIG. 7 (a) shows Nyquist plots (Z′ vs −Z″) after 1 cycle for the cathodes of Example 1 and Comparative Example 1, and FIG. 7(b) shows Nyquist plots (Z′ vs −Z″) after 20 cycles for the cathodes of Example 1 and Comparative Example 1.

The following Table 2 summarizes charge-transfer resistance coefficients after 1 cycle for the cathodes of Example 1 and Comparative Example 1.

TABLE 2

| 1 Cycle | Rₛ | R_{f} | R_{ct} |
|---|---|---|---|
| Example 1 | 2.2 Ω | 3.5 Ω (±0.1) | 5.12 Ω (±0.1) |
| Comparative Example 1 | 2.5 Ω | 2.6 Ω (±0.1) | 5.27 Ω (±0.1) |

The following Table 3 summarizes charge-transfer resistance coefficients after 20 cycles for the cathodes of Example 1 and Comparative Example 1.

TABLE 3

| 20 Cycles | Rₛ | R_{f} | R_{ct} |
|---|---|---|---|
| Example 1 | 3.8 Ω | 7.3 Ω (±0.1) | 7.7 Ω (±0.1) |
| Comparative Example 1 | 3.5 Ω | 11 Ω (±0.1) | 11.7 Ω (±0.1) |

Referring to Table 2, Table 3 and FIG. 7, surface resistance of the batteries of Example 1 and Comparative Example 1 was measured under a condition of 4.3 V for the analysis. The first semicircle is resistance (R_{f}) of the solid electrolyte interface, and the second semicircle means charge transfer resistance (R_{ct}). After 20 cycles, transparent R_{f} and R_{ct} semicircles were formed. The R_{f} value of Comparative Example 1 increased from 2.6Ω to 11Ω, and the R_{f} value of Example 1 increased from 3.5Ω to 7.3Ω. In addition, the R_{ct} value of Comparative Example 1 increased from 5.27Ω to 11.7Ω, and the R_{ct} value of Example 1 increased from 5.12Ω to 7.7Ω. Example 1 showed reduced resistance compared to Comparative Example 1. It was identified that a porous nanofiber structure provided with a carbon coating layer provides a short distance of electron/ion diffusion to relieve lattice expansion and contraction during repeated insertion/extraction, and the carbon coating suppresses side reactions with an electrolyte, thereby reducing a resistance value.

Hereinbefore, the present disclosure has been described with limited examples, however, the present disclosure is not limited thereto, and it is obvious that various changes and modifications may be made by those skilled in the art within technical ideas of the present disclosure and the range of equivalents of the claims to be described.

1. A method for manufacturing a cathode active material, the method comprising:
preparing a mixture solution including a raw material quantified in a chemical stoichiometric ratio according to a composition formula of Li[NiₓM₁₋ₓ]O₂ (0.85≤x≤0.93, M is Mn, Co, V, Cr, Cu, Ti or Zn), a chelating agent and a solvent;
preparing a nanofiber by electrospinning the mixture solution; and
heat treating the nanofiber to prepare a cathode active material provided with a carbon coating layer on a surface of the nano fiber.

2. The method of claim 1, wherein M is Co, and the raw material includes lithium nitrate hexahydrate (LiNO₃·6H₂O), nickel nitrate hexahydrate (Ni(NO₃)₂·6H₂O) and cobalt nitrate hexahydrate (Co(NO₃)₂·6H₂O).

3. The method of claim 1, wherein the chelating agent includes at least one of polyvinyl pyrrolidine (PVP), polyvinyl acetate (PVAc), polyvinyl alcohol (PVA), polyethylene (PE), polypropylene (PP) and poly(3,4-ethylenedioxythiophene) (PEDOT).

4. The method of claim 1, wherein, in the mixture solution, a content of the chelating agent is 10 parts by weight or greater and 20 parts by weight or less with respect to 100 parts by weight of the raw material.

5. The method of claim 1, wherein the electrospinning is performed in a voltage range of 10 kV or greater and 30 kV or less and a TCD (tip-to-collector distance) range of 5 cm or greater and 20 cm or less.

6. The method of claim 1, wherein the heat treating of the nanofiber includes a first heat treatment performed at a temperature of 400° C. or higher and 550° C. or lower and a second heat treatment performed at a temperature of 600° C. or higher and 900° C. or lower.

7. A cathode active material manufactured using the method of claim 1, the cathode active material comprising:
a nanofiber having a composition formula of Li[NiₓM₁₋ₓ]O₂ (0.85≤x≤0.93, M is Mn, Co, V, Cr, Cu, Ti or Zn); and
a carbon coating layer provided on a surface of the nanofiber.

8. The cathode active material of claim 7, wherein the nanofiber has an average diameter of 300 nm or greater and 900 nm or less.

9. The cathode active material of claim 7, wherein the nanofiber includes a crystalline active material.
